(19) United States
(12) Patent Application Publication
(10) Pub. No.: US 2024/0172098 A1
(43) Pub. Date: May 23, 2024

(54) TERMINAL

(71) Applicant: NTT DOCOMO, INC., Tokyo (JP)

(72) Inventors: Syunsuke Oohara, Tokyo (JP); Tetsuhiro Sasagawa, Tokyo (JP)

(73) Assignee: NTT DOCOMO, INC., Tokyo (JP)

(21) Appl. No.: 18/549,990

(22) PCT Filed: Mar. 11, 2022
(86) PCT No.: PCT/JP2022/010906

§ 371 Date: Sep. 11, 2023

(30) Foreign Application Priority Data
Mar. 12, 2021 (JP) 2021-040819

(51) Int. Cl. H04W 48/14; H04M 1/675; H04W 8/18

(52) U.S. Cl. CPC H04W 48/14; H04M 1/675; H04W 8/18

(57) ABSTRACT

A terminal receives, from a network, a profile that is configured in an embedded subscriber identity module and in which an active or inactive state can be externally controlled. The terminal transmits, to the network, a request for controlling the active or inactive state of the profile. The terminal controls the active or inactive state of the profile in accordance with instruction information for the request.

### TECHNICAL FIELD

The present invention relates to a terminal that performs radio communication, and in particular, a terminal that includes an embedded subscriber identity module.

### BACKGROUND ART

The GSM association (GSMA) specifies remote subscriber identity module provisioning (RSP), in which a profile including data including subscriber information and an application that controls use of a communication service is downloaded from a network to a terminal at the time of subscribing to the communication service (see Non-Patent Literature 1).

In the RSP, the terminal sets the downloaded profile in an embedded subscriber identity module (eSIM). Accordingly, the terminal can perform line opening processing at the time of subscribing to the communication service via the network using the eSIM. Note that the software part in which the profile is rewritten is called an eSIM, whereas the hardware part is called an embedded universal integrated circuit card (eUICC).

During actual use, specific subscriber information needs to be activated in the eSIM. From the terminal/network (NW), the eSIM is only recognized as a SIM in which only activated subscriber information is written, and when there is no activated subscriber information, the eSIM is recognized as a SIM without subscriber information.

### CITATION LIST

### Non-Patent Literature

Non-Patent Literature 1: GSMA SGP.21 RSP Architecture Version 2.2, September 2017

### SUMMARY OF THE INVENTION

In recent years, the number of eSIM-compatible terminals has increased, and as an example, the number of eSIM-compatible terminals used as business phones or communication terminals for corporate use has also increased.

Conventionally, however, there was no mechanism to prevent off-duty hours use, and in the case of a SIM, it was necessary to insert and remove the SIM.

Therefore, the present invention has been made in view of such a situation, and an object of the present invention is to provide a terminal, a server, a communication system, and a communication method capable of externally controlling use of an eSIM-compatible terminal.

A terminal (200) according to an aspect of the present invention includes: a receiving unit (220) that receives, from a network (20), a profile that is configured in an embedded subscriber identity module (250) and in which an active or inactive state is able to be externally controlled; a transmitting unit (210) that transmits, to the network (20), a request for controlling the active or inactive state of the profile; and a control unit (240) that controls the active or inactive state of the profile in accordance with instruction information for the request.

A server (600) according to an aspect of the present invention includes: a receiving unit (620) that receives a request for controlling an active or inactive state of a profile, which is transmitted from a terminal (200) in which the profile in which the active or inactive state is able to be externally controlled is configured in an embedded subscriber identity module (250); and a transmitting unit (610) that transmits, to the terminal (200), instruction information for the request for controlling the active or inactive state of the profile.

A communication system according to an aspect of the present invention includes: a terminal (250) including a receiving unit (220) that receives, from a network (20), a profile that is configured in an embedded subscriber identity module (250) and in which an active or inactive state is able to be externally controlled, a transmitting unit (210) that transmits, to the network (20), a request for controlling the active or inactive state of the profile, and a control unit (240) that controls the active or inactive state of the profile in accordance with instruction information for the request; a receiving unit (620) that receives, from the terminal (250), the request for controlling the active or inactive state of the profile; and a transmitting unit (610) that transmits, to the terminal (200), the instruction information for the request for controlling the active or inactive state of the profile.

A communication method according to an aspect of the present invention includes: a step of receiving a request for controlling an active or inactive state of a profile, which is transmitted from a terminal in which the profile in which the active or inactive state is able to be externally controlled is configured in an embedded subscriber identity module (250) to a network (20); and a step of transmitting, from the network (20) to the terminal (100), instruction information for the request for controlling the active or inactive state of the profile.

### BRIEF DESCRIPTION OF DRAWINGS

FIG. 1 is an overall schematic configuration diagram of a communication system 10.

FIG. 2 is a functional block configuration diagram of a terminal 200.

FIG. 3 is a functional block configuration diagram of an information management server 600.

FIG. 4 is a diagram illustrating a flow of various types of information in the communication system 10.

FIG. 5 is a diagram illustrating an operation sequence in the communication system 10.

FIG. 6 is a diagram illustrating an example of a hardware configuration of a radio base station 100, a terminal 200, a contract site 300, an SM server 400, a customer management server 500, and an information management server 600.

### DESCRIPTION OF EMBODIMENTS

Embodiments will be described below with reference to the drawings. Note that the same functions and configurations are denoted by the same or similar reference numerals, and the description thereof will be omitted as appropriate.

### (1) Overall Schematic Configuration of Communication System

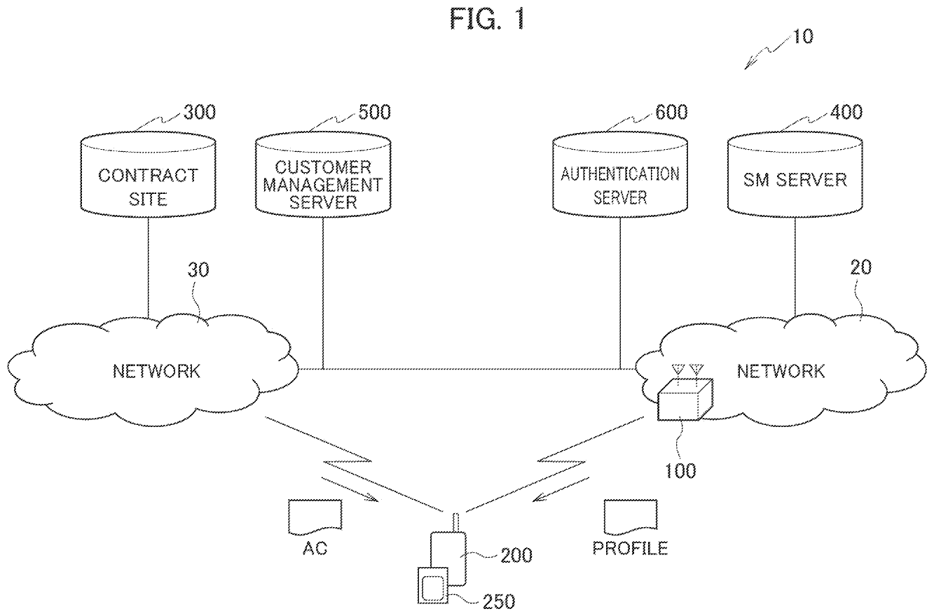

FIG. 1 is an overall schematic configuration diagram of a communication system 10 according to the present embodiment.

As illustrated in FIG. 1, the communication system 10 includes a network 20 such as a 3GPP network, a network 30 such as a non-3GPP network, a radio base station 100, a terminal 200, a contract site 300, a subscription management (SM) server 400, an information management server 600, and a customer management server 500. The terminal is also referred to as user equipment (UE). The contract site is also referred to as an operator or a communication carrier. Note that the specific configuration of the communication system 10 including the number of devices (contract site 300, subscription management (SM) server 400, information management server 600, customer management server 500, and the like) in the network and the number of radio base stations and terminals is not limited to the example illustrated in FIG. 1. For example, the server on the network side may be only one device at the minimum that implements the present invention, and in the following embodiment, at least one device of the radio base station 100, the contract site 300, the subscription management (SM) server 400, the information management server 600, and the customer management server 500 may be omitted, and the function of the corresponding device may be held by another device.

The network 20 is a network according to 5G (NR) (or 6G) such as a 3GPP network, and includes a next generation-radio access network (NG-RAN, not illustrated) and a core network (5G-CN, not illustrated). The NG-RAN includes an NG-RAN node, specifically, the radio base station 100 (gNB or ng-eNB), and is connected to the 5G-CN.

The radio base station 100 performs radio communication according to the NR between the radio base station 100 and the terminal 200.

The radio base station 100 and the terminal 200 can support massive MIMO that generates beams with higher directivity by controlling radio signals transmitted from a plurality of antenna elements, carrier aggregation (CA) that uses a plurality of component carriers (CCs), dual connectivity (DC) that simultaneously transmits CCs between a plurality of NG-RAN nodes and the terminal, integrated access and backhaul (IAB) in which a radio backhaul between radio communication nodes such as a gNB and radio access to the UE are integrated, and the like. Note that CC is also referred to as a carrier.

Note that the network 20 may be a network according to LTE instead of NR or 6G. In this case, the 3GPP network 20 includes an evolved universal terrestrial radio access network (E-UTRAN) and an evolved packet core (EPC). The E-UTRAN includes a radio base station (eNB or en-gNB) and is connected to the EPC.

The network 30 is a non-3GPP network or the like, and is a wireless local area network (wireless LAN) such as wireless fidelity (Wi-Fi) or a wired LAN. The network 30 is not particularly limited as long as the terminal 200 can access the contract site 300 using a uniform resource locator (URL) or the like.

The terminal 200 executes an RSP that downloads a profile including data including subscriber information and an application for controlling use of the communication service from the 3GPP network 20 at the time of subscribing to the communication service. The profile may be referred to as a production profile.

The subscriber information includes an international mobile subscriber identifier (IMSI) uniquely assigned to users who use the communication service, a telephone number uniquely assigned to users who use the communication service, contract information including a billing plan applied to the terminal 200, and the like. The subscriber information is provided from the contract site 300.

In the RSP, in the present embodiment, as will be described later, at the time of attachment to the 3GPP network 20, the terminal 200 transmits a download request for a profile corresponding to an activation code (AC) received from the network 30 at the time of subscribing to the communication service to the radio base station 100 via the 3GPP network 20. Upon receiving the profile request from the terminal 200, the radio base station 100 transmits (transfers) the profile request to the SM server 400.

In the present embodiment, as will be described later, the terminal 200 downloads, from the SM server 400 via the 3GPP network 20 in the RSP, a profile in which an active or inactive state can be externally controlled. The terminal 200 can use a communication service in the 3GPP network 20 by installing the downloaded profile in an embedded subscriber identity module (eSIM) 250 to be described later and activating the profile.

Note that, in the present embodiment, the profile is initially in an inactive state, or may be brought into an inactive state by a timer or the like, or may be brought into an inactive state in accordance with instruction information. In the present embodiment, a request for controlling the active or inactive state of the profile is transmitted to the network, instruction information for the request is received from the network, and the terminal 200 controls the active or inactive state of the profile in accordance with the instruction information. In the present embodiment, the network device that receives the request and transmits the instruction information may be described as the information management server 600, but the network device is not limited thereto, and another device (e.g., the customer management server 500 or the SM server 400) may perform the processing.

The profile may have limited use of the profile. For example, a valid period (for example, 10 hours, or from 9:00 AM to 5:00 PM, etc.) may be set in the profile. When the valid period has passed, the profile shifts to an inactive state.

In addition, regardless of whether or not there is a request, when instruction information for shifting to the inactive state is received from the network, control may be performed to shift to the inactive state.

The contract site 300 is connected to a network (the network 20 and/or the network 30). Upon receiving the contract information (IMEI, EID, and the like) based on the communication contract, the contract site 300 transmits the contract information to the customer management server 500, and the customer management server 500 transmits a profile generation request to the SM server 400 based on the contract information. In addition, the customer management server 500 transmits at least IMEI (further, an EID, a telephone number, and the like may be added) included in the contract information to the information management server 600.

The SM server 400 is connected to a network (the network 20 and/or the network 30). Upon receiving the profile generation request, the SM server 400 generates a profile and transmits an AC including an SM address and a matching ID (identifier associated with the profile) to the customer server 500. The customer server 500 transmits the AC to the contract site 300, and the contract site 300 transmits the AC to the terminal 200 via the network 30. Note that the profile initially generated by the SM server 400 may be referred to as a temporary profile. In this case, the configuration may be such that the production profile is not transmitted to the terminal 200 but the temporary profile is transmitted to the terminal 200 at first, and the production profile is transmitted to the terminal 200 only when instruction information for approval is issued in response to the activation request transmitted from the terminal 200.

When receiving a request for downloading a profile corresponding to the AC from the terminal 200 via the network 20, the SM server 400 transmits the profile to the terminal 200.

Note that, in the present embodiment, the profile is a profile in which an active or inactive state can be externally controlled (as a specific example, a profile in which an active or inactive state can be controlled only from the outside), and the network (including the SM server 400, the customer management server 500, the information management server 600, or the like) transmits instruction information for controlling the terminal 200 so that the profile can be activated only when the activation request transmitted from the terminal 200 is approved. Note that an entity who approves the request may be a manager terminal 200′ (or a user of the manager terminal 200′) of information (IMEI, EID, and the like) of a manager associated with information (IMEI, EID, and the like) of a managed person who is a user of the terminal 200.

The customer management server 500 is connected to a network and manages contract information and the like such as subscriber information. In the present embodiment, the customer management server 500 holds parent-child information in which information of a managed person (IMEI, EID, and the like of the terminal 200) and information of a manager (IMEI, EID, and the like of the terminal 200′) are associated with each other based on information at the time of subscribing to a corporate mobile phone or the like. The customer management server 500 transmits the parent-child information to the information management server 600. In the description of the present embodiment, the information management server 600 holds the parent-child information and transmits the instruction information from the manager for the request from the managed person. However, the present invention is not limited thereto, an entity that holds the parent-child information, an entity that receives the request, and an entity that transmits the instruction information are arbitrary, and may be, for example, any one of the contract site 300, the SM server 400, and the customer management server 500.

The information management server 600 is connected to the network, holds parent-child information in which information of the managed person (IMEI, EID, and the like of the terminal 200) and information of the manager (IMEI, EID, and the like of the terminal 200′) are associated with each other in a reference table, transfers a request transmitted from the terminal 200 of the managed person to the terminal 200′ of the corresponding manager based on the parent-child information, and transmits, to the terminal 200 of the managed person, instruction information for controlling an active/inactive state based on information indicating approval/disapproval from the manager terminal 200′.

### (2) Functional Block Configuration of Communication System

Next, a functional block configuration of the communication system 10 will be described. Specifically, functional block configurations of the terminal 200 and the information management server 600 will be described. Only parts related to features in the present embodiment will be described below. Therefore, it is a matter of course that the terminal 200 and the information management server 600 include other functional blocks that are not directly related to the features in the present embodiment. In addition, some or all of the functions of the contract site 300, the information management server 600, the customer management server 500, the SM server 400, the radio base station 100, and the like may be held on behalf of another device, and the other device may have the following functional block configurations (the transmitting unit, the receiving unit, and the control unit) of the SM server 400.

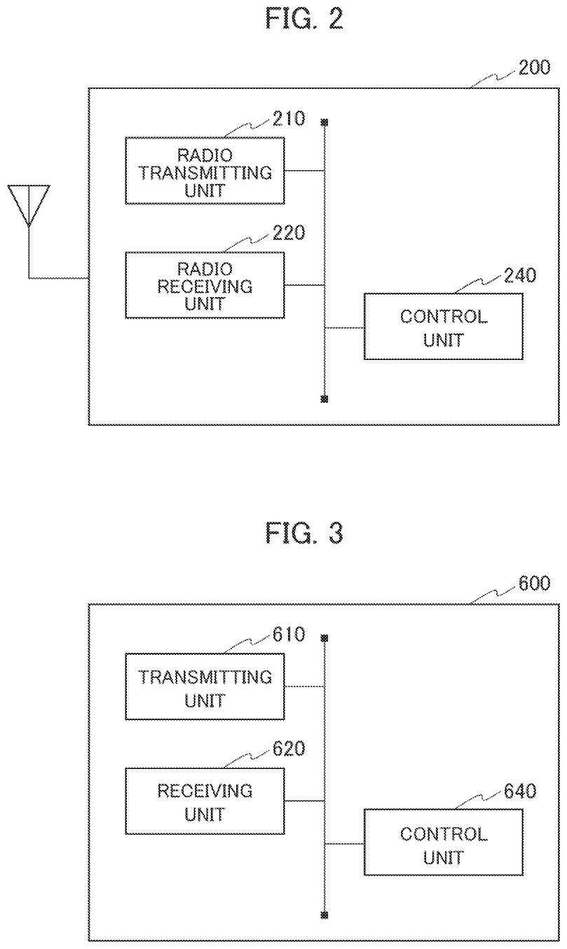

For convenience, first, a functional block configuration diagram of the terminal 200 will be described. FIG. 2 is a functional block configuration diagram of the terminal 200. As illustrated in FIG. 2, the terminal 200 includes a radio transmitting unit 210, a radio receiving unit 220, and a control unit 240.

The radio receiving unit 220 receives a downlink signal (DL signal) according to the NR from the radio base station 100. In the present embodiment, the radio receiving unit 220 functions as a receiving unit that receives, from the network 20, a profile that is configured in the eSIM and in which an active or inactive state can be externally controlled.

The radio transmitting unit 210 transmits an uplink signal (UL signal) according to the NR to the radio base station 100. In the present embodiment, the radio transmitting unit 210 functions as a transmitting unit that transmits, to the network 20, a request for controlling the active or inactive state of the profile.

Note that the radio transmitting unit 210 and the radio receiving unit 220 perform radio communication via a control channel or a data channel.

The control channel includes a physical downlink control channel (PDCCH), a physical uplink control channel (PUCCH), a physical random access channel (PRACH), and the like.

The data channel includes a physical downlink shared channel (PDSCH), a physical uplink shared channel (PUSCH), and the like.

At the time of subscribing to the communication service, the radio transmitting unit 210 transmits information regarding the contract (IMEI, EID, and the like) to the contract site 300 via the network 30. Note that, in the present embodiment, since a contract for a corporate mobile phone or the like is assumed, it is assumed that the terminal 200′ of the manager transmits information regarding the contract (IMEI, EID, and the like of the manager and IMEI, EID, and the like of the managed person) to the contract site 300 via the network 30 at the time of subscribing to the communication service.

The radio receiving unit 220 receives the AC based on the contract information from the customer management server 500 (or the contract site 300) via the network 30. Note that, in the present embodiment, it is assumed that based on the contract information transmitted from the terminal 200′ of the manager, the AC is transmitted to the terminal 200 corresponding to the information (IMEI, EID, and the like) of the managed person associated with the information (IMEI, EID, and the like) of the manager via the network 30.

The radio transmitting unit 210 transmits a profile request corresponding to the received AC to the SM server 400 via the network 20. The radio receiving unit 220 receives the profile corresponding to the AC from the SM server via the network 30. As described above, the initial profile may be a profile in the inactive state.

The control unit 240 has a function such as a local profile assistant (LPA), downloads a profile from the SM server 400, and installs the profile in the eSIM 250. The control unit 240 sets the profile installed in the eSIM 250 to the active/inactive state based on the instruction information and the like. For example, when instruction information indicating approval for the activation request is received, the control unit 240 may shift the profile in the inactive state to the active state.

Furthermore, when timer information such as a valid period is included in the profile, the active/inactive state may be controlled based on the information.

Note that the eSIM 250 is the software part in which the profile is written. The hardware portion in which the profile is written is referred to as an embedded universal integrated circuit card (eUICC).

The profile installed in the eSIM 250 allows the network (in other words, the outside or manager) to control the active/inactive state of the profile, that is, the available/unavailable state of the eSIM, without physically inserting or removing a subscriber identity module (SIM).

When the activated profile does not exist in the eSIM 250, the eSIM 250 is recognized as a SIM in which no profile is written from the network side.

The eSIM 250 has a shape that cannot be removed from the terminal 200, but is not limited thereto, and may have a shape that can be removed from the terminal 200.

In addition, the control unit 240 controls each functional block configuring the terminal 200. The control unit 240 performs an operation of attaching to the 3GPP network 20.

FIG. 3 is a functional block configuration diagram of the information management 400. As illustrated in FIG. 3, the information management server 600 includes a transmitting unit 610, a receiving unit 620, and a control unit 640.

The receiving unit 420 receives various types of information (e.g., parent-child information, activation request, etc.) via the network. In the present embodiment, the receiving unit 420 receives parent-child information from the customer management server 500. Furthermore, in the present embodiment, the receiving unit 420 receives a request for controlling the active or inactive state of the profile from the terminal 200. Furthermore, the receiving unit 420 may refer to a reference table holding parent-child information for information (IMEI, EID, and the like) of the user (managed person) of the terminal 200 that has transmitted the request, and may receive information indicating approval/disapproval of the request from the manager terminal 200′ of the corresponding manager information (IMEI, EID, and the like).

The transmitting unit 410 transmits various types of information (e.g., request, instruction information, etc.) via the network. In the present embodiment, the transmitting unit 410 may refer to the reference table holding the parent-child information for information (IMEI, EID, and the like) of the user (managed person) of the terminal 200 that has transmitted the request, and may transmit the request to the manager terminal 200′ of the corresponding manager information (IMEI, EID, and the like). Furthermore, in the present embodiment, the transmitting unit 410 functions as a transmitting unit that transmits, to the terminal 200, instruction information for a request for controlling the active or inactive state of the profile.

The control unit 440 controls each functional block configuring the information management server 600. In the present embodiment, as an example, the control unit 140 may refer to the reference table holding the parent-child information for information (IMEI, EID, and the like) of the user (managed person) of the terminal 200 that has transmitted the request, and read the corresponding manager information (IMEI, EID, and the like).

### (3) Operation of Communication System

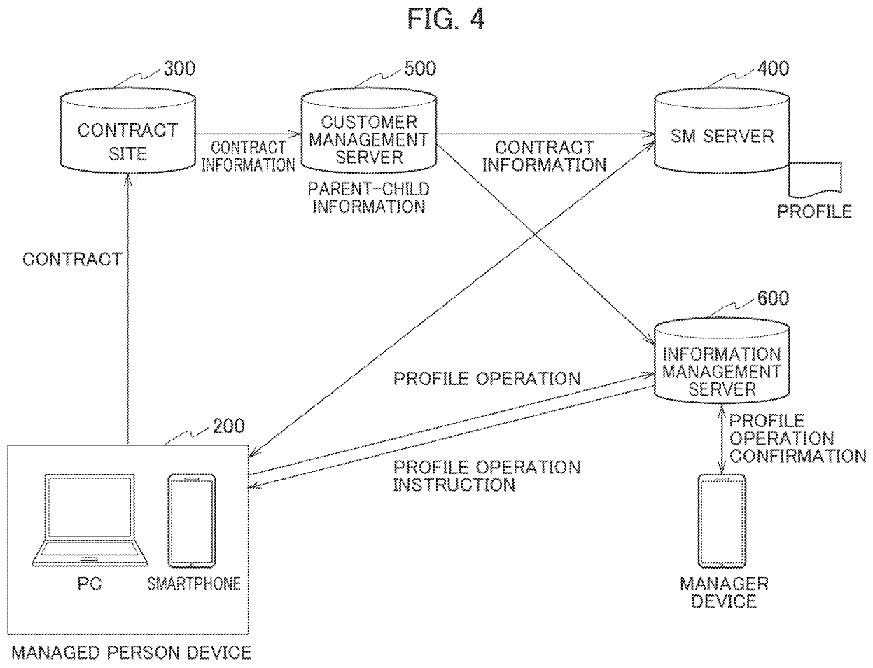

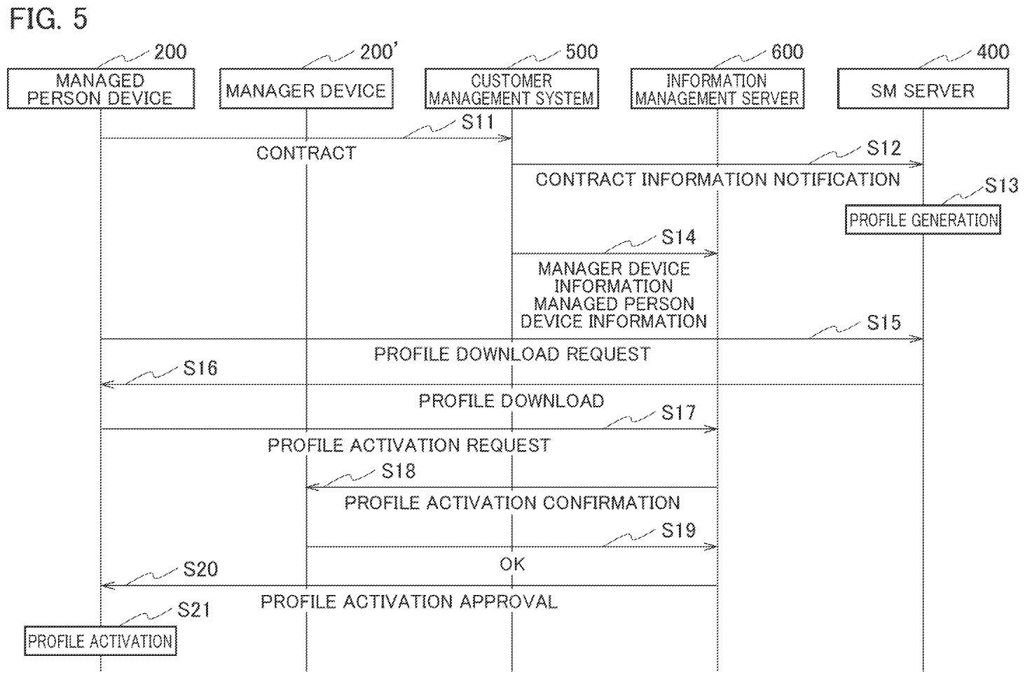

Next, an operation of the communication system 10 will be described. Specifically, an example of a specific operation when there is a profile activation request will be described with reference to FIGS. 4 and 5. It goes without saying that the present embodiment is not limited to these specific examples. For example, in the following description, the entity who inquires the parent-child information will be described as the information management server 600, but the present invention is not limited thereto, and another device such as the customer management server 500 may make the inquiry. Furthermore, the device that approves/disapproves the request is not limited to the terminal 200′ of the manager, and may be another device (a manager or the like who operates another device). For example, the manager may log in to the information management server 600 or the like and input approval/disapproval for the request. Alternatively, the information management server 600 or the like may make an IP telephone call to the telephone number of the manager based on the parent-child information, and play an automatic voice saying “There has been a request for activation from a non-manager. Please enter 1 for approval or 0 for disapproval”, and the information management server 600 or the like may transmit instruction information to the terminal 200 based on information of 1 (approved) or 0 (disapproved) or the like transmitted from the terminal 200′ of the manager via the IP telephone.

### (3.1) Specific Operation Example

FIG. 4 is a diagram illustrating a flow of various types of information in the communication system 10. FIG. 5 is a diagram illustrating an operation sequence in the communication system 10.

As illustrated in FIGS. 4 and 5, the terminal 200 of the managed person (and/or the terminal 200′ of the manager) connects to the network 30 to access the contract site 300. At this time, when the terminal 200 transmits information regarding the contract (IMEI, EID, subscriber information, and the like) to the contract site 300, the contract information is transmitted to the customer management server 500 (S11).

Upon receiving the contract information, the customer management server 500 transmits a profile generation request to the SM server 400 (S12). Upon receiving the profile generation request, the SM server 400 generates a profile (S13). In addition, the customer management server 500 generates parent-child information in which information (information such as IMEI, EID, and telephone number) of the terminal 200 of the managed person is associated with information (information such as IMEI, EID, and telephone number) of the terminal 200′ of the manager, and transmits the parent-child information to the information management server 600 (S14).

Here, the customer management server 500 may transmit an AC including an SM address, a matching ID, and the like corresponding to the profile to the terminal 200.

The terminal 200 accesses the SM server 400 based on the AC including the SM address, the matching ID, and the like, and transmits a profile download request to the SM server 400 (S15).

The SM server 400 transmits a profile in an inactive state to the terminal 200 based on the profile request (S16). Then, the terminal 200 configures the downloaded profile in the inactive state in the eSIM.

Subsequently, the terminal 200 transmits a request for activating the profile to the information management server 600 (S17).

Based on the parent-child information in the reference table, the information management server 600 reads information (IMEI, EID, telephone number, and the like) of the manager associated with information (IMEI, EID, telephone number, and the like) of the user (managed person) of the terminal 200 that has transmitted the request, and transmits an activation request to the terminal 200′ of the corresponding manager (S18).

Upon receiving response information indicating that the activation is approved (OK) from the terminal 200′ of the manager (S19), the information management server 600 transmits instruction information for approving the activation of the profile to the terminal 200 of the managed person (S20).

Accordingly, the terminal 200 of the managed person can activate the inactive profile based on the instruction information, and can perform communication via the 3GPP network 20.

### (4) Action and Effect

According to the embodiment described above, a request for controlling the active or inactive state of the profile is received, which is transmitted from the terminal 200 in which the profile in which the active or inactive state can be externally controlled is configured in the eSIM 250 to the network 20, and instruction information for the request for controlling the active or inactive state of the profile is transmitted from the network 20 to the terminal 100.

With such a configuration, the active or inactive state of the eSIM profile can be controlled from the outside, and therefore the use of the eSIM communication can be controlled from the outside.

For this reason, as an example, even when the eSIM-compatible terminal is used as a business phone or a communication terminal for corporate use, it is possible to provide a mechanism that can restrict off-duty hours use.

Furthermore, in the present embodiment, the request is a request for activating the inactive profile, and the control unit 240 activates the inactive state of the profile in accordance with instruction information indicating approval for the request.

Accordingly, the eSIM communication can be used only when the request for activation is approved by an external manager or the like. Therefore, even in a situation where the profile is inactive outside business hours and its use is restricted, a mechanism can be provided for it to be used with approval from a manager or the like.

Furthermore, in the present embodiment, the request includes information regarding the managed person, and the control unit 240 controls the active or inactive state of the profile in accordance with the instruction information indicating approval or disapproval from the manager associated with the information regarding the managed person.

Accordingly, it is possible to control the active or inactive state of the profile by requesting an approval from an appropriate manager for the request from a managed person based on the parent-child information or the like regarding the combination of the manager and the managed person set at the time of contract. For example, in a case where an employer is set as a manager and an employee is set as a managed person at the time of subscribing to a corporate mobile phone, when there is an eSIM use request corresponding to a request for overtime work from the employee, the employer can approve whether or not to permit the overtime work and manage the working environment and the like of employees.

### (5) Other Embodiments

Although the contents of the present invention have been described above according to the embodiments, it is obvious to those skilled in the art that the present invention is not limited to these descriptions, and that various modifications and improvements can be made.

The block configuration diagrams (FIGS. 2 and 3) used to describe the above-described embodiments illustrate blocks in functional units. These functional blocks (components) are implemented by an arbitrary combination of at least one of hardware and software. A method for implementing each functional block is not particularly limited. That is, each functional block may be implemented by using one physically or logically combined device, or may be implemented by directly or indirectly connecting two or more physically or logically separated devices (for example, wired, wireless, etc.) and using these plural devices. The functional block may be implemented by combining software with the one device or the plural devices mentioned above.

The functions include determining, deciding, judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating, mapping, assigning, and the like. However, the functions are not limited thereto. For example, a functional block (component) that makes a transmitting function work is referred to as a transmitting unit or a transmitter. In any case, as described above, the implementation method is not particularly limited.

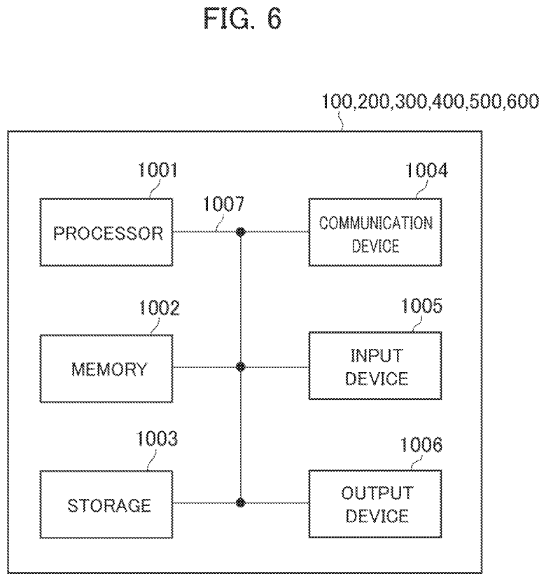

Further, the radio base station 100, the terminal 200, the contract site 300, the SM server 400, the customer management server 500, and the information management server 600 described above may function as a computer that performs processing of the radio communication method of the present disclosure. FIG. 6 is a diagram illustrating an example of a hardware configuration of the device.

As illustrated in FIG. 6, the device may be configured as a computer device including a processor 1001, a memory 1002, a storage 1003, a communication device 1004, an input device 1005, an output device 1006, a bus 1007, and the like.

In the following description, the term “device” can be read as a circuit, a device, a unit, or the like. The hardware configuration of the device may include one or more of the devices illustrated in the drawings, or may not include some of the devices.

Each functional block of the device is implemented by any of hardware elements of the computer device or a combination of the hardware elements.

Furthermore, each function of the device is implemented by loading predetermined software (program) on hardware such as the processor 1001 and the memory 1002 so that the processor 1001 performs arithmetic operations to control communication by the communication device 1004 and to control at least one of reading and writing of data on the memory 1002 and the storage 1003.

The processor 1001 operates, for example, an operating system to control the entire computer. The processor 1001 may be configured with a central processing unit (CPU) including an interface with a peripheral device, a control device, an arithmetic device, a register, and the like.

In addition, the processor 1001 reads a program (program code), a software module, data, and the like from at least one of the storage 1003 and the communication device 1004 into the memory 1002, and executes various processes in accordance with these. As the program, a program that causes a computer to execute at least part of the operations described in the above-described embodiments is used. Furthermore, the above-described various processes may be executed by one processor 1001, or may be executed simultaneously or sequentially by two or more processors 1001. The processor 1001 may be implemented by one or more chips. The program may be transmitted from a network via an telecommunication line.

The memory 1002 is a computer-readable recording medium, and may be configured with, for example, at least one of a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can store a program (program code), a software module, and the like that can execute the method according to one embodiment of the present disclosure.

The storage 1003 is a computer-readable recording medium, and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The above-described recording medium may be, for example, a database including at least one of the memory 1002 and the storage 1003, a server, or another appropriate medium.

The communication device 1004 is hardware (transmission/reception device) for performing communication between computers via at least one of a wired network and a wireless network, and is also referred to as, for example, a network device, a network controller, a network card, a communication module, or the like.

The communication device 1004 may include a high-frequency switch, a duplexer, a filter, a frequency synthesizer, and the like in order to implement, for example, at least one of frequency division duplex (FDD) and time division duplex (TDD).

The input device 1005 is an input device (for example, a keyboard, a mouse, a microphone, a switch, a button, a sensor, or the like) that accepts an input from the outside. The output device 1006 is an output device (for example, a display, a speaker, an LED lamp, and the like) that performs an output to the outside. Note that the input device 1005 and the output device 1006 may be integrated (for example, a touch screen).

In addition, the respective devices such as the processor 1001 and the memory 1002 are connected to each other with the bus 1007 for communicating information. The bus 1007 may be configured with a single bus or may be configured using different buses for each device-to-device.

Furthermore, the device may include hardware such as a microprocessor, a digital signal processor (DSP), an application specific integrated circuit (ASIC), a programmable logic device (PLD), and a field programmable gate array (FPGA), and a part or all of each functional block may be implemented by the hardware. For example, the processor 1001 may be implemented using at least one of these pieces of hardware.

Furthermore, the notification of information is not limited to that in the aspects/embodiments described in the present disclosure, and may be performed using other methods. For example, the notification of information may be performed by physical layer signaling (for example, downlink control information (DCI), uplink control information (UCI)), higher layer signaling (for example, RRC signaling, medium access control (MAC) signaling), broadcast information (master information block (MIB), system information block (SIB)), other signals, or a combination thereof. Furthermore, the RRC signaling may also be referred to as an RRC message, and may be, for example, an RRC connection setup message, an RRC connection reconfiguration message, or the like.

Each aspect/embodiment described in the present disclosure may be applied to at least one of systems using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), and other appropriate systems, and next-generation systems extended based on these. Also, a plurality of systems may be applied in combination (for example, a combination of at least one of LTE and LTE-A with 5G, or the like).

The order of the processing procedure, sequence, flowchart, and the like of each aspect/embodiment described in the present disclosure may be exchanged as long as there is no contradiction. For example, the methods described in the present disclosure present the elements of various steps by using an example order, and are not limited to the presented specific order.

The specific operation that is performed by the base station in the present disclosure may be performed by its higher node (upper node) in some cases. It is obvious that in a network including one or more network nodes having a base station, various operations performed for communication with a terminal may be performed by at least one of the base station and other network nodes (for example, MME or S-GW may be considered, but not limited thereto) other than the base station. Although the case is exemplified above where there is one network node other than the base station, a combination of a plurality of other network nodes (for example, MME and S-GW) may be used.

Information and signals (information and the like) may be output from the higher layer (or lower layer) to the lower layer (or higher layer). Input and output may be performed via a plurality of network nodes.

The input and output information may be stored in a specific location (for example, memory) or may be managed using a management table. The input and output information may be overwritten, updated, or added. The output information may be deleted. The input information may be transmitted to another device.

The determination may be made by a value represented by one bit (0 or 1), may be made by truth-value (Boolean: true or false), or may be made by comparison of numerical values (for example, comparison with a predetermined value).

Each aspect/embodiment described in the present disclosure may be used alone, or may be used in combination, or may be switched with execution. Furthermore, notification of predetermined information (for example, notification of “being X”) is not limited to being performed explicitly, and may be performed implicitly (for example, the predetermined information is not notified).

Regardless of being referred to as software, firmware, middleware, microcode, hardware description language, or some other names, software should be construed broadly to mean instructions, instruction sets, code, code segments, program code, programs, subprograms, software modules, applications, software applications, software packages, routines, subroutines, objects, executable files, execution threads, procedures, functions, and the like.

In addition, software, instructions, information, and the like may be transmitted and received via a transmission medium. For example, when software is transmitted from a website, server, or other remote source using at least one of a wired technology (a coaxial cable, an optical fiber cable, a twisted pair, a digital subscriber line (DSL), or the like) and a wireless technology (infrared lights, microwaves, and the like), at least one of these wired and wireless technologies is included within the definition of the transmission medium.

The information, signals, and the like described in the present disclosure may be represented using any of a variety of different technologies. For example, data, instructions, commands, information, signals, bits, symbols, chips, and the like that may be mentioned throughout the above description may be represented by voltages, currents, electromagnetic waves, magnetic fields or particles, optical fields or photons, or any combination thereof.

Note that the terms described in the present disclosure and the terms necessary for understanding the present disclosure may be replaced with terms having the same or similar meanings. For example, at least one of a channel and a symbol may be a signal (signaling). The signal may also be a message. In addition, a component carrier (CC) may be referred to as a carrier frequency, a cell, a frequency carrier, or the like.

The terms “system” and “network” used in the present disclosure are used interchangeably.

In addition, the information, the parameter, and the like described in the present disclosure may be represented using an absolute value, may be represented using a relative value from a predetermined value, or may be represented using another corresponding information. For example, radio resources may be indicated by an index.

The names used for the parameters described above are not limiting names in any way. Furthermore, formulas and the like using these parameters may be different from those explicitly disclosed in the present disclosure. Since various channels (for example, PUCCH, PDCCH, and the like) and information elements can be identified by any suitable name, various names allocated to these various channels and information elements are not restricted in any way.

In the present disclosure, terms such as “base station (BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” may be used interchangeably. The base station may also be referred to with terms such as macrocell, small cell, femtocell, pico cell, or the like.

The base station can accommodate one or more (for example, three) cells (also referred to as sectors). When the base station accommodates a plurality of cells, the entire coverage area of the base station can be divided into a plurality of smaller areas, and each smaller area can also provide a communication service by a base station subsystem (for example, a small base station for indoor use (remote radio head: RRH)).

The term “cell” or “sector” refers to a part or the whole of a coverage area of at least one of a base station and a base station subsystem that performs communication service in this coverage.

In the present disclosure, the terms such as “mobile station (MS)”, “user terminal”, “user equipment (UE)”, “terminal”, and the like may be used interchangeably.

The mobile station may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of the base station and the mobile station may be referred to as a transmitting device, a receiving device, a communication device, or the like. Note that at least one of the base station and the mobile station may be a device mounted on a moving body, the moving body itself, or the like. The moving body may be a vehicle (for example, a car, an airplane, or the like), an unmanned moving body (for example, a drone, a self-driving vehicle, or the like), or a robot (manned type or unmanned type). Note that at least one of the base station and the mobile station includes a device that does not necessarily move during the communication operation. For example, at least one of the base station and the mobile station may be an Internet of Things (IoT) device such as a sensor.

In addition, the base station in the present disclosure may be read as a mobile station (user terminal, hereinafter the same). For example, each aspect/embodiment of the present disclosure may be applied to a configuration in which communication between a base station and a mobile station is replaced with communication between a plurality of mobile stations (for example, it may be referred to as device-to-device (D2D), vehicle-to-everything (V2X), or the like). In this case, the mobile station may have the function of the base station. In addition, words such as “uplink” and “downlink” may be read as words corresponding to terminal-to-terminal communication (for example, “side”). For example, an uplink channel, a downlink channel, or the like may be replaced with a side channel.

Similarly, the mobile station in the present disclosure may be read as a base station. In this case, the base station may have the function of the mobile station.

A radio frame may be composed of one or more frames in time domain. Each of the one or more frames in the time domain may be referred to as a subframe.

The subframe may further be composed of one or more slots in the time domain. A subframe may have a fixed time length (for example, 1 ms) that is independent of numerology.

The numerology may be a communication parameter applied to at least one of transmission and reception of a signal or channel. The numerology may indicate at least one of, for example, a subcarrier spacing (SCS), a bandwidth, a symbol length, a cyclic prefix length, a transmission time interval (TTI), the number of symbols per TTI, a radio frame configuration, a specific filtering process performed by the transceiver in the frequency domain, a specific windowing process performed by the transceiver in the time domain, and the like.

The slot may be composed of one or more symbols (orthogonal frequency division multiplexing (OFDM)) symbols, a single carrier frequency division multiple access (SC-FDMA) symbol, and the like in the time domain. The slot may be a time unit based on the numerology.

The slot may include a plurality of minislots. Each minislot may be composed of one or more symbols in the time domain. Further, the minislot may be referred to as a subslot. The minislot may be composed of fewer symbols than the slot. A PDSCH (or PUSCH) transmitted in a time unit greater than the minislot may be referred to as a PDSCH (or PUSCH) mapping type A. A PDSCH (or PUSCH) transmitted using the minislot may be referred to as a PDSCH (or PUSCH) mapping type B.

The radio frame, the subframe, the slot, the minislot, and the symbol all represent a time unit when a signal is transmitted. The radio frame, the subframe, the slot, the mini-slot, and the symbol may have respectively different names corresponding to them.

For example, one subframe may be referred to as a transmission time interval (TTI), a plurality of consecutive subframes may be referred to as a TTI, or one slot or one minislot may be referred to as a TTI. That is, at least one of the subframe and the TTI may be a subframe (1 ms) in existing LTE, a period shorter than 1 ms (for example, 1-13 symbols), or a period longer than 1 ms. Note that the unit representing the TTI may be referred to as a slot, a minislot, or the like instead of a subframe.

Here, the TTI refers to, for example, a minimum time unit of scheduling in radio communication. For example, in the LTE system, a base station performs scheduling of allocating radio resources (frequency bandwidth, transmission power, and the like that can be used in each user terminal) to each user terminal in units of TTIs. Note that the definition of the TTI is not limited thereto.

The TTI may be a transmission time unit such as a channel-encoded data packet (transport block), a code block, or a code word, or may be a processing unit such as scheduling or link adaptation. Note that, when a TTI is given, a time interval (for example, the number of symbols) in which a transport block, a code block, a code word, or the like is actually mapped may be shorter than the TTI.

When one slot or one minislot is referred to as a TTI, one or more TTIs (that is, one or more slots or one or more minislots) may be the minimum time unit of scheduling. Furthermore, the number of slots (the number of minislots) constituting the minimum time unit of the scheduling may be controlled.

A TTI having a time length of 1 ms may be referred to as an ordinary TTI (TTI in LTE Rel.8-12), a normal TTI, a long TTI, an ordinary subframe, a normal subframe, a long subframe, a slot, or the like. A TTI shorter than the ordinary TTI may be referred to as a shortened TTI, a short TTI, a partial TTI (partial or fractional TTI), a shortened subframe, a short subframe, a minislot, a subslot, a slot, or the like.

Note that the long TTI (for example, an ordinary TTI, a subframe, or the like) may be read as a TTI having a time length exceeding 1 ms, and the short TTI (for example, a shortened TTI or the like) may be read as a TTI having a TTI length less than the TTI length of the long TTI and having the TTI length of 1 ms or more.

A resource block (RB) is a resource allocation unit in the time domain and the frequency domain, and may include one or more consecutive subcarriers in the frequency domain.

The number of subcarriers included in the RB may be the same regardless of the numerology, for example, 12. The number of subcarriers included in the RB may be determined based on the numerology.

In addition, the time domain of the RB may include one or more symbols, and may be a length of one slot, one minislot, one subframe, or one TTI. One TTI, one subframe, and the like may each be composed of one or more resource blocks.

Note that one or more RBs may be referred to as a physical resource block (PRB), a sub-carrier group (SCG), a resource element group (REG), a PRB pair, an RB pair, or the like.

In addition, the resource block may be composed of one or more resource elements (REs). For example, one RE may be a radio resource domain of one subcarrier and one symbol.

A bandwidth part (BWP) (which may also be referred to as partial bandwidth or the like) may represent a subset of consecutive common resource blocks (RBs) for a certain numerology in a certain carrier. Here, the common RB may be specified by an index of the RB based on the common reference point of the carrier. The PRB may be defined by a certain BWP and numbered within the BWP.

The BWP may include a BWP for UL (UL BWP) and a BWP for DL (DL BWP). One or more BWPs may be configured in one carrier for the UE.

At least one of the configured BWPs may be active and the UE may not assume transmitting or receiving a given signal/channel outside the active BWPs. Note that “cell”, “carrier”, and the like in the present disclosure may be read as “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in an RB, the number of symbols in a TTI, a symbol length, a cyclic prefix (CP) length, and the like can be variously changed.

The terms “connected”, “coupled”, or any variation thereof, mean any direct or indirect connection or coupling between two or more elements, and may include that one or more intermediate elements are present between two elements that are “connected” or “coupled” to each other. The coupling or connection between the elements may be physical, logical, or a combination thereof. For example, “connection” may be read as “access”. As used in the present disclosure, two elements can be considered to be “connected” or “coupled” to each other using at least one of one or more wires, cables, and printed electrical connections and using, as some non-limiting and non-exhaustive examples, electromagnetic energy having wavelengths in a radio frequency range, a microwave range, and a light (both visible and invisible) range, and the like.

A reference signal can also be abbreviated as RS, or may also be referred to as a pilot according to an applicable standard.

As used in the present disclosure, the description “based on” does not mean “based only on” unless explicitly stated otherwise. In other words, the description “based on” means both “based only on” and “based at least on”.

Any reference to elements using designations such as “first”, “second”, and the like as used in the present disclosure does not generally limit the amount or order of those elements. These designations may be used in the present disclosure as a convenient way to distinguish between two or more elements. Thus, references to first and second elements do not imply that only two elements can be adopted, or that the first element must precede the second element in any way.

Where the present disclosure uses the terms “include”, “including”, and variations thereof, these terms are intended to be inclusive in a manner similar to the term “comprising”. Furthermore, the term “or” used in the present disclosure is intended not to be an exclusive-OR.

In the present disclosure, for example, when articles such as a, an, and the in English are added by translation, the present disclosure may include a case where a noun following these articles is used in plural.

The terms “determining” used in the present disclosure may encompass a wide variety of actions. The terms “determining” may include deeming that determining has been performed by, for example, judging, calculating, computing, processing, deriving, investigating, searching (looking up, search, inquiry) (for example, searching in a table, a database, or another data structure), ascertaining, and the like. Also, “determining” may include deeming that determining has been performed by receiving (for example, receiving information), transmitting (for example, transmitting information), inputting (input), outputting (output), and accessing (for example, accessing data in a memory), and the like. In addition, “determining” may include deeming that determining has been performed by resolving, selecting, choosing, establishing, comparing, and the like. That is, “determining” may include deeming that “determining” regarding some action has been performed. Further, “determining” may be read as “assuming”, “expecting”, “considering”, or the like.

In the present disclosure, the term “A and B are different” may mean “A and B are different from each other”. The term may also mean that “A and B are different from C”. Terms such as “separated”, “coupled”, and the like may also be interpreted in the same manner as “different”.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Communication system
20 (3GPP) Network
30 (Non-3GPP) Network
100 Radio base station
200 Terminal
210 Radio transmitting unit
220 Radio receiving unit
240 Control unit
300 Contract Site
400 Subscription management (SM) server
500 Customer management system
600 Authentication server
610 Transmitting unit
620 Receiving unit
640 Control unit
1001 Processor
1002 Memory
1003 Storage
1004 Communication device
1005 Input device
1006 Output device
1007 Bus

1. A terminal comprising:
a receiving unit that receives, from a network, a profile that is configured in an embedded subscriber identity module and in which an active or inactive state is able to be externally controlled;
a transmitting unit that transmits, to the network, a request for controlling the active or inactive state of the profile; and
a control unit that controls the active or inactive state of the profile in accordance with instruction information for the request.

2. The terminal according to claim 1,
wherein the request is a request for activating the inactive profile, and
the control unit activates the inactive state of the profile in accordance with instruction information indicating approval for the request.

3. The terminal according to claim 1,
wherein the request includes information regarding a managed person, and
the control unit controls the active or inactive state of the profile in accordance with the instruction information indicating approval or disapproval from a manager associated with the information regarding the managed person.

4. A server comprising:
a receiving unit that receives a request for controlling an active or inactive state of a profile, which is transmitted from a terminal in which the profile in which the active or inactive state is able to be externally controlled is configured in an embedded subscriber identity module; and
a transmitting unit that transmits, to the terminal, instruction information for the request for controlling the active or inactive state of the profile.

5. A communication system comprising:
a terminal including
a receiving unit that receives, from a network, a profile that is configured in an embedded subscriber identity module and in which an active or inactive state is able to be externally controlled,
a transmitting unit that transmits, to the network, a request for controlling the active or inactive state of the profile, and
a control unit that controls the active or inactive state of the profile in accordance with instruction information for the request; and
a server including
a receiving unit that receives the request from the terminal, and
a transmitting unit that transmits, to the terminal, the instruction information for the request.

6. A communication method comprising:
a step of receiving a request for controlling an active or inactive state of a profile, which is transmitted from a terminal in which the profile in which the active or inactive state is able to be externally controlled is configured in an embedded subscriber identity module to a network; and
a step of transmitting, from the network to the terminal, instruction information for the request for controlling the active or inactive state of the profile.

7. The terminal according to claim 2,
wherein the request includes information regarding a managed person, and
the control unit controls the active or inactive state of the profile in accordance with the instruction information indicating approval or disapproval from a manager associated with the information regarding the managed person.
